(19) United States
(12) Patent Application Publication
(10) Pub. No.: US 2015/0192222 A1
(43) Pub. Date: Jul. 9, 2015

(54) Apparatus and Method for Laying Pipes

(71) Applicant: CEONA SERVICES (UK) LIMITED, London Greater London (GB)

(72) Inventors: Stephen John Preston, Stevenage Hertfordshire (GB); Erwin Lammertink, Heemstede (NL)

(73) Assignee: CEONA SERVICES (UK) LIMITED, London Greater London (GB)

(21) Appl. No.: 14/412,901

(22) PCT Filed: Jul. 10, 2013
(86) PCT No.: PCT/GB2013/051817

§ 371 Date: Jan. 5, 2015

(30) Foreign Application Priority Data
Jul. 10, 2012 (GB) 1212378.2

(51) Int. Cl. F16L 1/16; F16L 58/02; F16L 57/00; F16L 1/26; B63B 35/03

(52) U.S. Cl. CPC F16L 1/161; F16L 1/26; B63B 35/03; F16L 57/00; F16L 58/02

(57) ABSTRACT

The present invention provides an apparatus for use in laying a submarine pipeline. The apparatus includes a vessel having a deck area, alignment means on the deck area which aligns pipe sections to form a pipeline, guidance means for guiding the pipeline and discharge means that are mounted onto the deck area of the vessel and receive the pipeline. The apparatus also includes tensioner means for controlling the movement of the pipeline and an exit port in the deck area for the passage of the pipeline from the discharge means into the water. The alignment means are inclined with respect to the longitudinal axis of the vessel or with respect to the horizontal plane of the deck of the vessel or inclined with respect to both.

The invention relates to an apparatus and method for the laying of submarine pipes, umbilicals and cables from a vessel at sea, particularly rigid pipes. In the remainder of this document, when pipes are referred to, it applies equally to umbilicals and cables.

According to known processes, pipes are laid from a vessel using either a so-called J-lay method of installation or a so-called S-lay method. Each method is named by the general shape of the pipe as it leaves the vessel and is laid on the seafloor. An S-lay involves the pipe being passed over a stinger at the rear of the vessel to control the path of the pipe and maintain it in an essentially straight orientation for as long as possible. This is the preferred method for laying pipes in shallower waters. The J-lay method uses a substantially vertical tower to control the laying of the pipe. The pipe either passes from a reel on the vessel up and through a tower or it passes from an on-board welding station to go up and through the tower. It then leaves the tower in a substantially vertical direction so that the pipe only experiences one bend, namely as it reaches the seabed. This method is good for pipes which are rigid or have low elastic deformation, or those pipes which have a large diameter or a coating, for example concrete.

When the pipe is a rigid pipe and is either taken from a reel or is welded in location on the vessel and is subjected to plastic deformation, then it will be necessary to have one or more straighteners present to straighten the pipe before it is laid. This is only necessary if there is plastic deformation, and if the bending is within the elastic limits of the pipe then no straighteners will be necessary. The speed of laying for such rigid pipes is substantially affected by the length of any firing line where the rigid pipe sections are welded together to form the pipeline.

It is therefore an object of the present invention to provide an apparatus and method which is adaptable to be used with different types and sizes of pipe in both shallow and deep water and which increases the lay speed.

According to the present invention there is provided an apparatus for use in laying a submarine pipeline, the apparatus including a vessel having a deck area, alignment means on the deck area for aligning pipe sections to form a pipeline, guidance means for guiding the pipeline, discharge means mounted on the deck area for receiving the pipeline, tensioner means for controlling the movement of the pipeline, and an exit port in the deck area for the passage of the pipeline from the discharge means into the water, in which the alignment means are inclined with respect to the longitudinal axis of the vessel or with respect to the horizontal plane of the deck of the vessel or inclined with respect to both.

The inclination of the alignment means with respect either to the longitudinal axis of the vessel or the horizontal plane of the deck of the vessel increases the length of the line in the alignment area and hence increases the lay speed of the vessel. Preferably the inclination of the alignment means is such to maximise the length of the line in the alignment area and hence maximise the lay speed. If the inclination is with respect to the horizontal plane then it will also additionally minimise the bending of the pipeline from alignment to mounting on the discharge means. Advantageously, if the inclination is with respect to the horizontal plane, safer working conditions are achieved because the pipe sections do not have to be lifted as far from the deck of the vessel.

The inclination may be in the range of from 1 to 40°. Typically, inclination on the deck of the vessel with respect to the longitudinal axis of the vessel, angle β, will be of the order of 1 to 10°, such as in the range 1.5 to 8°, or 2 to 6° or 2.5 to 4.5°. Inclination with respect to the horizontal plane of the deck of the vessel, angle α, may be in the range 2.5 to 40°, such as 2.5 to 30°, or 3 to 25°, or 4 to 20°. In some embodiments, the alignment means will be inclined both to the longitudinal axis of the vessel, for example in the range 1 to 10°, and also inclined with respect to the horizontal plane, for example in the range 2.5 to 40°.

The inclination with respect to the horizontal plane may be towards the bow or towards the stern of the vessel. Similarly, the inclination with respect to the longitudinal axis of the vessel may be towards port or towards starboard.

The guidance means may be a rotatably mounted wheel or reel, or may be rollers or any suitable means for guiding the pipeline from the firing line to the discharge means. The guidance means may be aligned at any suitable orientation with respect to the longitudinal axis of the vessel to best guide the pipeline from the firing line to the discharge means. The guiding means may, therefore, be movable to accommodate variations in the angles α and 0.

The guidance means may be horizontally adjustable with respect to the longitudinal axis of the vessel. This allows the guidance means to be adjusted to maintain angle α for different diameter pipeline.

The discharge means may be a discharge wheel or reel rotatably mounted on the deck of the vessel, or it may be rollers or any other suitable means.

The guidance means may be arranged such that the pipeline is either elastically or plastically bent on either or both the entrance and/or the exit to the guidance means.

The discharge means may be arranged such that the pipeline is either elastically or plastically bent on either or both the entrance and/or the exit to the discharge means.

The apparatus may optionally include welding means and/or coating means within the alignment means on the deck area. Alternatively, there may be storage reels which feed pipe from a storage area and through the alignment means to the guidance means. The apparatus may also include straightening means for straightening the pipe. The straightening means may be placed at any suitable point in the process, but may preferably be placed after the discharge means and before the pipeline enters the water.

In another example, the apparatus may have first coating means positioned at an elevation above the deck and after the guidance means and before the discharge means. Optionally, there may also additionally or alternatively be coating means after the discharge means. If the coating means are not included within the alignment means, then more of this area can be used for welding the lengths of pipe together which will help increase the laying speed of the vessel.

The apparatus may optionally include further tensioning means within the alignment means on the deck area to assist in the control of the movement of the pipe to the guidance means.

The invention also extends to a method of laying a pipeline into water from a vessel, the method comprising: arranging a pipe along the deck of a vessel to form a pipeline, feeding the pipeline to guidance means, passing the pipeline over or through the guidance means and on to discharge means, passing the pipeline over, around or through the discharge means and through one or more tensioners and into a body of water, in which the movement of the pipeline is controlled by the tensioner and the pipeline on the deck is inclined at an angle either to the longitudinal axis of the vessel, or to the horizontal plane of the deck of the vessel or inclined with respect to both.

The step of arranging the pipe along the deck at an inclination either to the longitudinal axis of the vessel or to the horizontal plane of the deck of the vessel or both may additionally include the step of welding substantially straight sections of pipe together to form a pipeline. Alternatively, the pipeline may be stored on the vessel on storage reels and as the pipe is unwound from the storage reels, a first end of a first pipe is joined to a first end of a second pipe to form a single pipeline before it is passed to the guidance means and on to the discharge means.

The step of arranging the pipeline may optionally additionally include coating the pipeline with one or more coatings before it is laid. The partial or full coating of the pipeline may take place before the guidance means, or between the guidance means and the discharge means, or after the discharge means, or in any combination of these positions.

The method may also include the step of passing the pipeline through one or more straighteners. These straighteners may be placed at any suitable point in the process, for example, after the discharge means and before the pipeline enters the water.

The method may optionally include further tensioner means within the step of arranging the pipeline to help control the loading of the pipeline on to the guide wheel.

The invention will now be explained in more detail with reference to the accompanying figures, which show two embodiments of the present method and system.

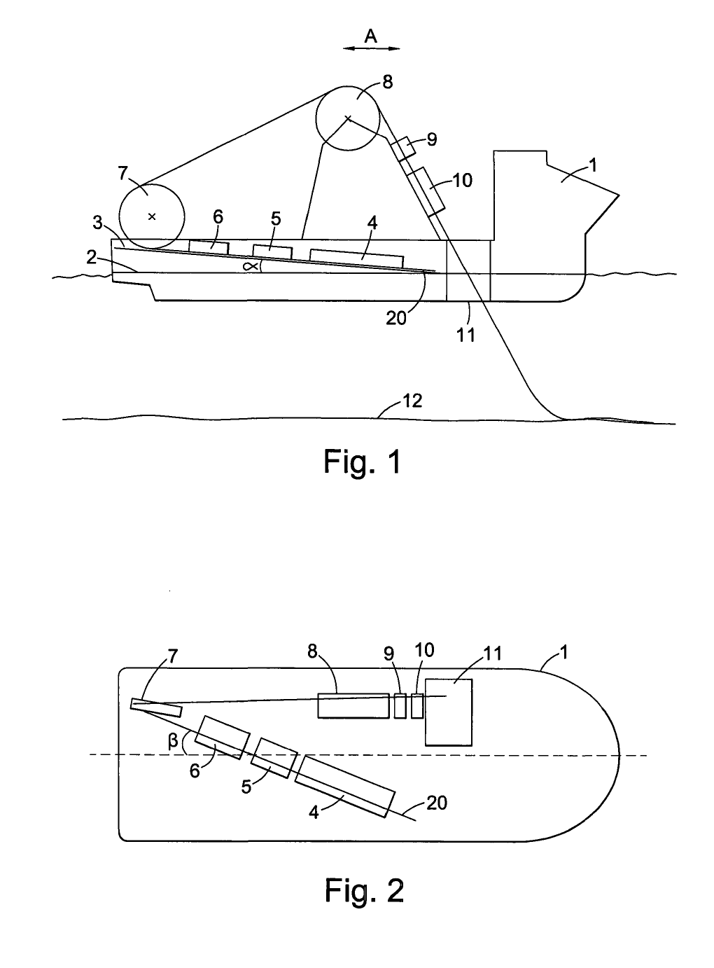

FIG. 1 shows schematically an elevation view of a vessel according to one example of the present invention laying rigid pipes; and

FIG. 2 shows schematically a plan view of a vessel according to a second example of the present invention.

Referring to FIG. 1, there is shown a vessel 1 which includes a deck area 2 and an inclined alignment area 3 on which are positioned welding means 4, tensioner means 5 and coating means 6. The alignment area 3 is inclined at an angle α with respect to the horizontal plane of the deck of the vessel. The pipe 20 passes from suitable storage means (not shown) which may be any standard storage means such as reels of pipe or straight lengths of pipe section to the welding means 4 where they are welded together to form a single pipeline. The pipeline passes through a tensioner to help control the feed of the pipeline to guidance means 7 via the coating means 6 (if present). The guidance means may, for example, be a freely mounted rotatable wheel which is not powered.

The vessel may be a standard length vessel such that the deck area is up to 80 m long, for example in the range 25-80 m, or 50-75 m long. The welding means are any suitable means for joining adjacent sections of rigid pipe which are arranged to be transferred from a storage area to the deck. The sections of pipe are joined to form a pipeline 20 which may be coated as necessary, taking into account the environment where the pipeline is being laid. Suitable coatings may include fbe (fusion bonded epoxy) resins, polymers, etc.

The pipeline is fed over, around or through the guidance means 7 up to discharge means 8. This may also, for example, be a free mounted rotatable wheel or reel with a suitably textured and contoured surface to grip the pipeline 20 as it passes over the top of or around the reel 8. The pipeline 20 then passes through straightening means 9, and further tensioning means 10 before passing through a moonpool 11 in the bottom of the vessel 1 and down to the sea floor 12. Once a sufficient length of pipeline 20 has dropped to the seafloor 12, some or all of the tensioning means 10 may be switched off and the discharge of the pipeline 20 may be controlled solely by the tensioning means 5, friction on the discharge means 8 and gravity on the pipeline 20.

The tensioning means 5,10 may be conventional tensioners of a suitable size for the pipelines being laid. For example, they may be tensioners for holding up to 2000 metric tonnes (mt), for example in the range 200-2000 mt, or 300-1000 mt, or 300-700 mt, or 350-550 mt. Alternatively, the first tensioning means 5 could be a set of two or more tensioners of smaller size arranged in series such that one or more could be used in a particular project depending on the size and weight of the pipeline being laid. These tensioners may be of a size such as 200 mt, or 300 mt, or 400 mt or 500 mt. The tensioners not being used could be moved to one side so as not to get in the way of the pipeline as it is being fed to the guidance means 7.

Similarly, the second tensioning means could be a set of two or more tensioners of smaller size arranged in series such that one or more could be used in a particular project depending on the size and weight of the pipeline being laid. These tensioners may be of a size such as 200 mt, or 300 mt, or 400 mt or 500 mt. The tensioners not being used could be moved to one side so as not to get in the way of the pipeline as it is being discharged from the discharge means 8.

Alternatively, the second tensioner 10 may be of a much smaller size as the principle role of this could simply be to assist in the initial pulling of the pipeline 20 over, around or through the guidance means 7 and on to the discharge means 8. This could be done by means of a wire attached to the front end of the pipeline which is then passed over, around or through the guidance means 7 and discharge means 8 and through straightening means 9 to the tensioning means 10. This can then be fed through the tensioning means 10, pulling the assembled pipeline behind it until the pipeline reaches the tensioner 10. The tensioning means 10 may also take some of the weight of the pipeline 20 until a sufficient length has been laid for gravity to help control the speed of movement of the pipeline through the process.

The straightening means 9 are preferably arranged between the discharge means 8 and the tensioning means 10 to straighten out the pipeline 20 before it passes through the moonpool 11. This may not be needed if the diameter of the discharge means 8 is sufficiently large that the bending of the pipeline 20 is within the elastic limits of the pipeline so it will resume a substantially straight orientation after discharge from the discharge means 8. Where the discharge means are a wheel, the diameter may be of the order of 20 to 30 m, for example 25 to 28 m. On larger vessels the wheel could be even larger, for example 30-35 m in diameter, which may be useful for the laying of deepwater pipelines.

While a coating station has been shown within the alignment section on the deck of the vessel, the coating means could be positioned up from the deck at an elevated position after the guidance means 7. This would have the advantage of leaving more room for a longer welding station to be present which will have the beneficial effect of increasing the lay speed of the vessel. Alternatively or additionally, there may be coating means located after the discharge means and before the pipeline is passed through the moonpool and into the water. There may also be more than one coating required and these may be applied by any suitable combination of coating stations before or after the guidance means and the discharge means.

An alternative example of the vessel is shown schematically in plan view in FIG. 2. The same reference numerals are used to indicate the same features on the vessel 1. In this example the welding means 4, tensioning means 5 and coating means 6 are arranged to extend at an angle β to the longitudinal axis of the vessel 1. The guidance means 7 have been arranged such that the pipe is bent at both the entrance and exit to the guidance means 7. The discharge means 8 have also been arranged such that the pipe is bent upon entering and exiting the discharge means 8. Although alternatively, the guidance means 7 or discharge means 8 could be arranged such that the pipe is either not bent at all or only bent upon either entering or exiting the guidance or discharge means. This has the advantage of maximising the length of the firing line (welding and coating of the pipeline) for a given length of vessel. The length of the firing line directly influences the speed at which the pipeline can be laid, the lay speed of the vessel. An increase in the length of the firing line from, for example 75m along the longitudinal axis of the vessel to 80 m being inclined at an angle to the axis will result in an increase in the lay speed. As is known, the speed of lay of a vessel is determined by the longest cycle time of the individual welding, coating and testing stations on board the vessel. The longer the firing line can be made to be, the more stations can be included and therefore the shorter the individual time of each step will be and the quicker the vessel can lay pipeline. Similar benefits with the length of the firing line will also be achieved with the arrangement of FIG. 1, but that arrangement will also have benefits in reducing the degree of bending around the guidance means 7 and the discharge means 8.

When arranging the position of the guidance means 7 and discharge means 8 it is beneficial to reduce the degree that the pipe is bent in the horizontal plane of the deck of the vessel. Preferably the pipe is only bent to create elastic deformation of the pipe. This may minimise or avoid the need for straightening means and thereby reduce cost. Further, the less the pipe is bent, the more strength and fatigue life will remain for the use of the pipe once laid. It is therefore beneficial to introduce less stress and strain into the pipe during the construction and laying process.

It will be apparent that the arrangements of FIGS. 1 and 2 could be combined. For reasons of clarity this is not shown, but the firing line could be inclined at an angle α to the horizontal plane of the deck of the vessel and at an angle β to the longitudinal axis of the vessel. The increase in active length of the firing line for a set length of vessel would then be larger, and the benefit in the reduction in the degree of bending around the guide wheel would also be achieved.

The apparatus of the present invention could be used to lay flexible pipes as well where there would be no need to have a firing line with welding or straightening means.

The apparatus is suitable for laying pipes of all dimensions and constructions. For example it can be used to lay pipes of diameters in the range of 8-48 inches, for example 12-36 inches, or 16-24 inches or 8-24 inches. The pipes may be constructed of any suitable material, for example plastic, steel, carbon, composites or combinations of the above to meet the PIP standards.

As an optional feature, the discharge means 8 on the vessel 1 may be slid forwards or aft in the direction of arrow A. This will have the effect of altering the angle of discharge of the pipeline 20 through the moonpool 11 which will assist in the control of the discharge in different depths of water, As the water becomes deeper, it would be preferable to move away from an angled discharge towards a substantially vertical discharge of the pipeline 20.

As a further optional feature, the guidance means 7 on the vessel 1 may be slid forwards or aft in the direction of arrow A. This will have the effect of altering the angle α of the pipeline 20. If the coating means 6 are located beyond the guiding means 7, altering angle α enables the welded seams of the pipe sections to be situated in the same place of the coating means 6 regardless of which pipe diameter is being used. This therefore allows the coating means to be located in a fixed position.

1. An apparatus for use in laying a submarine pipeline, the apparatus comprising:
a vessel having a deck area, alignment means on the deck area for aligning pipe sections to form a pipeline, guidance means for guiding the pipeline, discharge means mounted on the deck area for receiving the pipeline, tensioner means for controlling the movement of the pipeline, and an exit port in the deck area for the passage of the pipeline from the discharge means into the water, wherein the alignment means are inclined with respect to the longitudinal axis of the vessel or with respect to the horizontal plane of the deck of the vessel or inclined with respect to both.

2. Apparatus as claimed in claim 1, wherein:
the inclination of the alignment means is in the range of from 1 to 40°.

3. Apparatus as claimed in claim 2, wherein:
the inclination on the deck with respect to the longitudinal axis of the vessel, angle β, is in the range of from 1 to 10°.

4. Apparatus as claimed in claim 3, wherein:
the range is from 1.5 to 8°.

5. Apparatus as claimed in claim 3, wherein:
the range is from 2 to 6°.

6. Apparatus as claimed in claim 3, wherein:
the range is from 2.5 to 4.5°.

7. Apparatus as claimed in claim 2, wherein:
the inclination with respect to the horizontal plane, angle α, is in the range of from 2.5 to 40°

8. Apparatus as claimed in claim 7, wherein:
the range is from 2.5 to 30°

9. Apparatus as claimed in claim 7, wherein:
the range is from 3 to 25°

10. Apparatus as claimed in claim 7, wherein:
the range is from 4 to 20°.

11. Apparatus as claimed in claim 1, wherein:
there is inclination with respect both to the longitudinal axis of the vessel and to the horizontal plane.

12. Apparatus as claimed in claim 11, wherein:
the inclination to the longitudinal axis of the vessel, angle β, is in the range 1 to 10°, and the inclination with respect to the horizontal plane, angle α, is in the range 2.5 to 40°.

13. Apparatus as claimed in claim 1, wherein:
the inclination with respect to the horizontal plane is upwards towards the bow of the vessel

14. Apparatus as claimed in claim 1, wherein:
the inclination with respect to the horizontal plane is upwards towards the stern of the vessel.

15. Apparatus as claimed in claim 1, wherein:
the alignment means further comprises: a welding means.

16. Apparatus as claimed in claim 1, wherein:
the alignment means further comprises: a coating means.

17. Apparatus as claimed in claim 1, wherein:
there are coating means placed between the guidance means and the discharge means.

18. Apparatus as claimed in claim 1, wherein:
there are coating means placed after the discharge means.

19. Apparatus as claimed in claim 1, wherein:
the apparatus further comprises: one or more sets of coating means positioned at one or more of the locations of: within the alignment means, between the guidance means and the discharge means, and after the discharge means.

20. Apparatus as claimed in claim 1, wherein:
the alignment means further comprises: a plurality of storage reels which feed pipe from and through the alignment means to the guidance means.

21. Apparatus as claimed in claim 1, wherein:
there are straightening means placed after the discharge means for straightening the pipeline before the pipeline enters the water.

22. Apparatus as claimed in claim 1, further comprising:
additional tensioning means within the alignment means on the deck area to assist in the control of the movement of the pipe.

23. Apparatus as claimed claim 1, wherein:
the guidance means are a freely mounted rotatable wheel or reel, or are a set of rolls or rollers.

24. Apparatus as claimed in claim 1, wherein:
the guidance means may be horizontally adjustable with respect to the longitudinal axis of the vessel.

25. Apparatus as claimed in claim 1, wherein:
the discharge means is one of a freely mounted rotatable wheel or reel, and a set of rolls or rollers.

26. Apparatus as claimed in claim 1, wherein:
the guidance means may be arranged such that the pipeline is either elastically or plastically bent on of at least one of the entrance and the exit to the guidance means.

27. Apparatus as claimed in claim 1, wherein:
the discharge means is arranged such that the pipeline is one of elastically or plastically bent on at least one of the entrance and the exit to the discharge means.

28. A method of laying a pipeline into water from a vessel, the method comprising the steps of:
arranging a pipe along the deck of a vessel to form a pipeline,
feeding the pipeline to guidance means,
passing the pipeline over, around or through the guidance means and on to discharge means,
passing the pipeline around, over or through the discharge means and through one or more tensioners and into a body of water, and
wherein the movement of the pipeline is controlled by the tensioner and the pipeline on the deck is inclined at an angle either to the longitudinal axis of the vessel, or to the horizontal plane of the deck of the vessel or inclined with respect to both.

29. The method as claimed in claim 28, wherein:
the step of arranging the pipe further comprises the steps of:
welding substantially straight sections of pipe together to form a pipeline.

30. The method as claimed in claim 28, wherein:
said pipes are stored on the vessel on storage reels and as the pipe is unwound from the storage reels, a first end of a first pipe is joined to a first end of a second pipe to form a single pipeline before it is passed on to the guidance means.

31. The method as claimed in claim 28, wherein:
the arrangement step additionally includes a step of coating the pipeline with one or more coatings.

32. The method as claimed in wherein:
the pipeline is passed through coating means between the guidance means and the discharge means.

33. The method as claimed in wherein:
the pipeline is passed through coating means after the discharge means and before the pipeline enters the water.

34. The method as claimed in wherein:
a second tensioner means is present within the arrangement means.

35. The method as claimed in wherein:
there is a further step of straightening the pipeline using straightening means after it has left the discharge means before it enters the water.
